(19) United States
(12) Patent Application Publication
(10) Pub. No.: US 2022/0292832 A1
(43) Pub. Date: Sep. 15, 2022

(54) A METHOD AND APPARATUS FOR CREATING A NETWORK OF SUBJECTS

(71) Applicant: NEC Corporation, Minato-ku, Tokyo (JP)

(72) Inventors: Hui Lam ONG, Singapore (SG); Satoshi YAMAZAKI, Singapore (SG); Wei Jian PEH, Singapore (SG); Qinyu HUANG, Singapore (SG)

(73) Assignee: NEC Corporation, Minato-ku, Tokyo (JP)

(21) Appl. No.: 17/639,435

(22) PCT Filed: Jul. 16, 2020
(86) PCT No.: PCT/JP2020/027643

§ 371 Date: Mar. 1, 2022

(30) Foreign Application Priority Data
Sep. 5, 2019 (SG) 10201908202R

(51) Int. Cl. G06V 20/52; G06V 20/40

(52) U.S. Cl. CPC G06V 20/52; G06V 20/41

(57) ABSTRACT

Present disclosure provides a method for creating a network of subjects based on a first group of subjects and a second group of subjects, comprising determining if at least one subject in the first group of subjects has an indirect co-appearance with at least one subject in the second group of subjects (302), the indirect co-appearance referring to an appearance of the at least one subject in the first group of subjects in a time period before or after the at least one subject in the second group of subjects; and determining a likelihood of weightage between the first group of subjects and the second group of subjects to create the network based on the determination of the indirect co-appearance (304).

### TECHNICAL FIELD

The present disclosure relates to a method and apparatus for creating a network of subjects based on a first group of subjects and a second group of subjects.

### BACKGROUND ART

Video analytics technologies are used to identify subject or a group of subjects using surveillance video footage. A group of subjects can be an organized crime group comprising instructors, cluster of subordinates, specialists, and other more transient members working together on a continuing basis for coordinating and planning of criminal activities. Law enforcement bodies have deployed video analytics technologies to monitor public areas and identify subject or a group of subjects as to assist crime prevention and investigations. Conventionally, a group of subjects is identified if two or more subjects appear during a same time period in a surveillance video footage. In particular, each group of subject will be identified if two or more subjects appear in each respective time periods in the surveillance video footage.

### SUMMARY OF INVENTION

### Technical Problem

However, many organized crime groups are often loose networks of criminals that come together for a specific criminal activity, acting in different roles depending on their skills and expertise. The criminals usually avoid appearing or being seen together to hide their connection during planning or execution of the activity, and make only indirect contact for information exchange with others in the group in crowded public area. This has hindered current video analytic technologies to associate them into a network of subjects for crime prevention and investigations. As a result, by convention, a first group of subjects and a second group of subjects may be identified in each respective time periods, even though the first group of subjects and the second group of subjects may come from an organized crime group. At present, no association or network is determined between the first group of subjects and the second group of subjects. Therefore, it is an object of present disclosure to substantially overcome the existing challenges as discussed above to create a network of subjects based on a first group of subjects and a second group of subjects.

### Solution to Problem

According to the present disclosure, there is provided a method for creating a network of subjects based on a first group of subjects and a second group of subjects, comprising determining if at least one subject in the first group of subjects has an indirect co-appearance with at least one subject in the second group of subjects, the indirect co-appearance referring to an appearance of the at least one subject in the first group of subjects in a time period before or after the at least one subject in the second group of subjects; and determining a likelihood of weightage between the first group of subjects and the second group of subjects to create the network based on the determination of the indirect co-appearance.

According to a second aspect of the present disclosure, there is provided an apparatus for creating a network of subjects based on a first group of subjects and a second group of subjects, comprising a memory in communication with a processor, the memory storing a computer program recorded therein, the computer program being executable by the processor to cause the apparatus at least to determine if at least one subject in the first group of subjects has an indirect co-appearance with at least one subject in the second group of subjects, the indirect co-appearance referring to an appearance of the at least one subject in the first group of subjects in a time period before or after the at least one subject in the second group of subjects; and determine a likelihood of weightage between the first group of subjects and the second group of subjects to create the network based on the determination of the indirect co-appearance.

According to yet another aspect of the present disclosure, there is provided a system for creating a network of subjects based on a first group of subjects and a second group of subjects, comprising the apparatus in the second aspect and at least one image capturing device.

### BRIEF DESCRIPTION OF DRAWINGS

The accompanying Figs., where like reference numerals and characters refer to identical or functionally similar elements throughout the separate views and which together with the detailed description below are incorporated in and form part of the specification, serve to illustrate various example embodiments and to explain various principles and advantages in accordance with present example embodiments in which:

FIG. 1A depicts a plurality of image frames comprising one or more appearance of a subject according to an example embodiment.

FIG. 1B depicts two image frames captured by an image capturing device identifying an appearance of a subject according to an example embodiment.

FIG. 1C depicts two image frames captured by more than one image capturing devices identifying an appearance of a subject within a same zone of a location according to another example embodiment.

FIG. 2A illustrates a block diagram demonstrating an identification of a direct co-appearance of two subjects according to various example embodiments.

FIG. 2B illustrates a block diagram demonstrating an example co-appearance search period of a subject according to an example embodiment.

FIG. 2C illustrates a block diagram demonstrating an identification of an indirect co-appearance of one subject and one other subject according to various example embodiments.

FIG. 3 shows a flow chart illustrating a method for creating a network of subjects based on a first group of subjects and a second group of subjects according to an example embodiment.

FIG. 4 depicts a block diagram illustrating a system for creating a network of subjects based on a first group of subjects and a second group of subjects according to an example embodiment.

FIG. 5 depicts an example of creating a network of subjects according to an example embodiment.

FIG. 6 depicts a flow chart illustrating a method of creating network of subjects according to an example embodiment.

FIG. 7 depicts a schematic diagram of a computer system suitable for use to implement the apparatus shown in FIG. 4.

### DESCRIPTION OF EMBODIMENTS

### Overview

Appearance—an appearance of a subject in a location based on a plurality of image frames detected by at least one image capturing device in the location. In various example embodiments below, one or more appearances of each subject is identified through characteristic information such as facial information.

Time period—a time period corresponds to an appearance of a subject that is identified in a continual period of time. In particular, start of a time period may be triggered upon detecting a subject in a location and end of a time period may be determined if the subject fails to appear and subsequently does not re-appear in the location within a configurable maximum appearance threshold. Specifically, determination of an appearance of the subject and a time period of the appearance of the subject may be performed to the point where the subject fails to appear if the subject does not re-appear in the location within a configurable maximum appearance threshold. For example if the maximum appearance threshold is configured to be two seconds, and if a subject appears on the first two seconds, disappears on the third second and the fourth second, an appearance of the subject is determined in a time period of the first two seconds. On the other hand, if the subject does not appear at a time but re-appear in the location within the maximum appearance threshold, determination of an appearance of the subject and a time period of the appearance may not be performed as if the subject appears continually. For example if the maximum appearance threshold is configured to be two seconds, and if a subject appears on the first two seconds, disappears on the third second but re-appear on the fourth second, the subject will be identified as continually appear from the first to the fourth seconds.

Co-appearance—a co-appearance is an appearance of at least two subjects identified from a plurality of image frames within a same zone of a location from one or more image capturing devices. A co-appearance can be further categorized into a direct co-appearance or an indirect co-appearance based on time periods in which the appearances of the at least two subjects are identified.

Direct co-appearance—a direct co-appearance refers to an overlap in appearance of two subjects in a same time period. In particular, two subjects are identified as in a direct co-appearance when there is an overlap in time period between respective time periods of the appearances of the two subjects, indicating the two subjects both appear in a location in a same time period at least during the overlapping time period. For example, if two subjects appear in time periods of 11:45:00 to 11:46:00 and 11:45:30 to 11:46:30, respectively, a direct co-appearance of the two subjects is identified as they co-appear in a same time period at least between 11:45:30 to 11:46:00.

Co-appearance search period—a co-appearance search period of one subject refers to an extended time period before and/or after a time period of an appearance of the subject. The extended time period before and/or after the time period of the appearance of the subject are configurable depending on applications. As such, a co-appearance search period may refer to one of the following: (i) extended time periods both before and after a time period of one subject, wherein each of the extended time periods may be configured differently, for example an extended time period of two seconds before the time period of the subject whereas an extended time period of ten seconds after the time period of the subject; (ii) an extended time period only before a time period of one subject, (iii) an extended time period only after a time period of one subject. The extended time periods in the co-appearance search period of the subject are mainly used to identify an indirect co-appearance, especially if respective time periods of two subjects do not overlap but spaced closely apart.

Indirect co-appearance—an indirect co-appearance refers to an appearance of one subject in a time period before or after one other subject. In particular, the appearances of the one subject and the other one subject only overlap in an extended time period of the one subject or of the other one subject, or of both. For example, an appearance of one subject is detected in a time period of 11:45:00 to 11:46:00, and an appearance of one other subject is detected in a time period of 11:46:20 to 11:47:20. No direct co-appearance is identified as their respective time periods do not overlap. A co-appearance search period of the one subject may include an extended time period of 30 seconds, extending the co-appearance search period of the subject with extended time periods of 11:44:30 to 11:45:00 and 11:46:00 to 11:46:30. As a result, the time period of the one other subject overlaps with the extended time periods of the one subject, at least in a time period between 11:46:20 to 11:46:30, thus an indirect co-appearance of the one subject and the one other subject is identified.

Group of subjects—a body representing one or more subjects in which the one or more subjects in the group of subjects are related to one another. In various example embodiments below, the group of subjects can be pre-determined by a shared feature or goal, or determined by a relationship drawn between the one or more subjects through a method, an apparatus or a system. A first group of subjects and a second group of subjects may refer to two distinct groups of subjects. For example, a group of subjects like the first group of subjects and the second group of subjects may be formed through direct co-appearances. Specifically, an appearance of two subjects in a same time period may be identified as a first group of subjects, an appearance of another two subjects in a same time period may be identified as a second group of subjects. If another subject has an appearance with at least one of the two subjects in the first group of subjects in a same time period, the another subject may also be identified as in the first group of subjects, which now the first group of subjects comprises at least three subjects based on the determination of the direct co-appearances. Additionally, it should be understood that the terms “first” and “second” are used herein to differentiate one element from another element and they do not imply any type of order (e.g. spatial, temporal, logical, etc.), for example, without deviating from the scope of the present disclosure, a first group of subjects may be referred as a second group of subjects, and similarly, a second group of subjects may also be referred to as a first group of subjects.

Number of direct co-appearances—a number of direct co-appearances refers to a count of direct co-appearances between two specific subjects during a plurality of time periods.

Number of indirect co-appearances—a number of indirect co-appearances refers to a count of indirect co-appearances between two specific subjects during a plurality of time periods. The subject may or may not be in a same group of subjects.

### EXEMPLARY EMBODIMENTS

Embodiments of the present disclosure will be better understood and readily apparent to one of ordinary skill in the art from the following written description, which provides examples only, and in conjunction with the drawings.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “retrieving”, “determining”, “replacing”, “generating”, “initializing”, “outputting”, “receiving”, “retrieving”, “identifying”, “predicting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and display presented herein are not inherently related to any particular computer or other apparatus. Various machines may be used with programs in accordance with the teachings herein. Alternatively, the construction of more specialized apparatus to perform the required method steps may be appropriated. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the internet system, or wireless medium such as exemplified in the GSM mobile telephone system. The computer program when loaded and executed on such as computer effectively results in an apparatus that implements the steps of the preferred method.

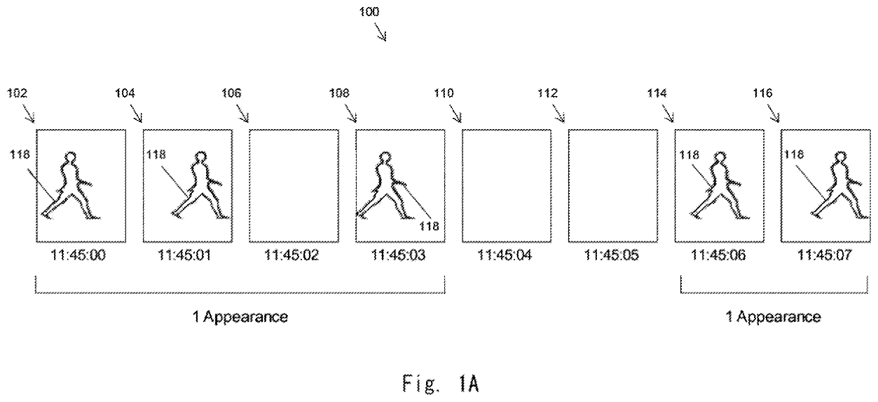

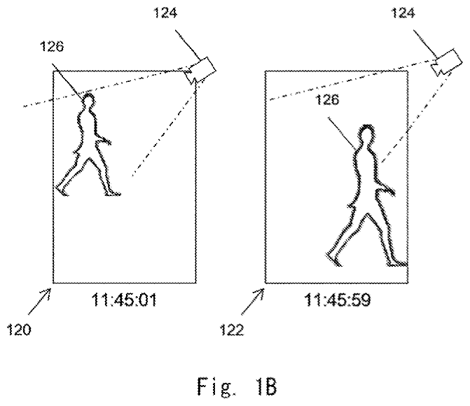

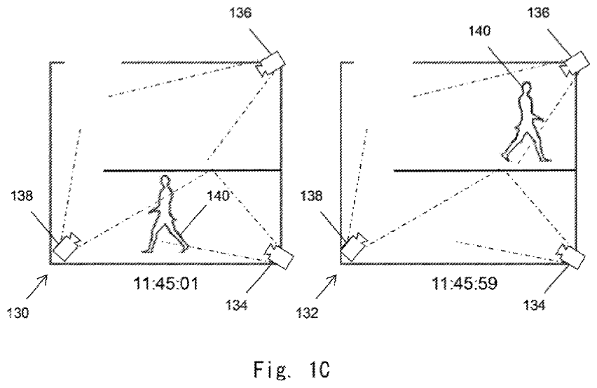

FIG. 1A depicts a plurality of image frames 100 comprising one or more appearance of a subject according to an example embodiment. The plurality of image frames 100 comprise eight image frames 102, 104, 106, 108, 110, 112, 114, 116 for one image frame per second between 11:45:00 and 11:45:07, respectively. In this example embodiment, a maximum appearance threshold of two seconds is configured. That is if a subject does not re-appear in two seconds, determination of an appearance of the subject and a time period of the appearance may be performed to the point where the subject fails to appear. For example in FIG. 1A, a subject 118 appears in frames 102, 104, 108 at 11:45:00, 11:45:01 and 11:45:03 respectively. The subject 118 is not detected in frame 106 at 11:45:02. The subject 118 re-appear in frame 108 at 11:45:03 that is within the maximum appearance threshold of two seconds, therefore the determination of the appearance of the subject and the time period may not be performed as if the subject appears continually from frame 102 to frame 108 in a continual time period between 11:45:00 to 11:45:03. Subsequently, the subject 118 is not detected in frames 110 and 112, and because the subject 118 fails to re-appear within the maximum appearance threshold of two seconds, an appearance of the subject may be determined as completed before the frame 110, from frames 102 and 108, with a time period of the appearance of the subject determined as between 11:45:00 and 11:45:03. The re-appearance of the subject 118 in frames 114 and 116 will be determined as a next appearance of the subject 118. As a result of this example embodiment, two appearances of the subject 118 are determined in the plurality of image frames 100 in time periods of 11:45:00 to 11:45:03 and 11:45:06 to 11:45:07 respectively.

FIG. 1B depicts two image frames 120, 122 captured by an image capturing device 124 identifying an appearance of a subject 126 according to an example embodiment. In this example embodiment, two image frames 120, 122 are captured by an image capturing device 124 at 11:45:01 and 11:45:59, respectively. A subject 126 appears in both of the image frames 120, 122 continually from 11:45:01 to 11:45:59. As a result, an appearance of the subject 126 can be identified at least in a time period of 11:45:01 to 11:45:59. FIG. 1C depicts two image frames 130, 132 captured by more than one image capturing devices 134, 136, 138 identifying an appearance of a subject 140 within a same zone of a location according to another example embodiment. In this example embodiment, two image frames 130, 132 are captured by three image capturing devices 134, 136, 138 within a same zone of a location at 11:45:01 and 11:45:59, respectively. A subject 140 appears in both of the image frames 130, 132 within the same zone of the location continually from 11:45:01 and 11:45:59. As a result, an appearance of the subject 140 in the location can be identified at least in a time period of 11:45:01 to 11:45:59.

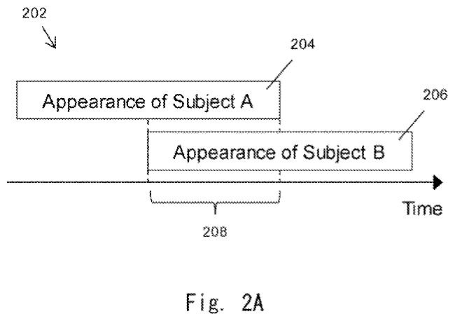

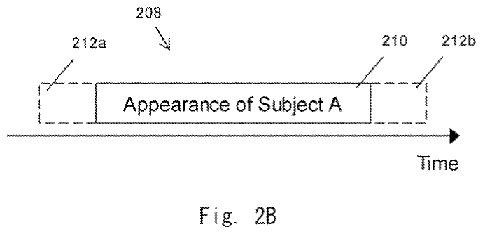

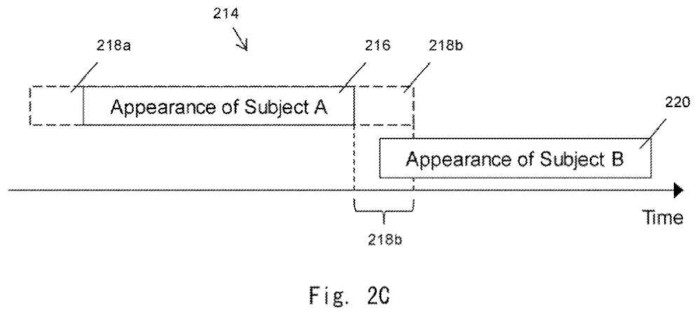

FIG. 2A illustrates a block diagram 202 demonstrating an identification of a direct co-appearance of two subjects according to various example embodiments. An appearance of two subjects, for example subject A and B, are detected in time periods 204, 206 respectively in a location. As illustrated in FIG. 2A, the respective time periods 204, 206 of subject A and subject B overlap in an time period 208 (or an overlapping time period 208). Correspondingly, the overlap of the time periods 204, 206 indicates that the two subjects, subject A and subject B, both appears in a same time period at least during the overlapping time period 208, as a result, an direct co-appearance between the two subjects is identified.

FIG. 2B illustrates a block diagram 208 demonstrating an example co-appearance search period of a subject according to an example embodiment. An appearance of a subject for example subject A is detected in a time period 210. A co-appearance search period of the subject for example may comprise an extended time period before 212a or after 212b the time period 210 of the subject. It is appreciated by one of ordinary skill in the art that an the extended time period before 212a and/or after 212b the time period 210 of the subject in the co-appearance search period can be configured differently depending on applications, for example, an extended time period of two seconds before 212a the time period 210 of the subject whereas an extended time period of ten seconds after 212b the time period 210 of the subject. In an example embodiment, a co-appearance search period of the subject may comprise only an extended time period before 212a the time period 210 of the subject. In another example embodiment, a co-appearance search period of the subject may comprise only an extended time period after 212b the time period 210 of the subject. A co-appearance search period is used to identify an indirect co-appearance, especially if respective time periods of appearances of two subjects do not overlap but spaced closely apart.

FIG. 2C illustrates a block diagram 214 demonstrating an identification of an indirect co-appearance of one subject and one other subject according to various example embodiments. An appearance of one subject, for example subject A, and an appearance of one other subject, for example subject B, are detected in time periods 216, 220 respectively in a location. In this example embodiment, the time period 216 of subject A does not overlap with the time period 220 of subject B, hence no direct co-appearance between subject A and subject B is identified. A co-appearance search period can be applied to the time period of subject A 216 and provide an extended time period before 218a or after 218b the time period of subject A 216. As a result, the time period of subject B 220 overlaps with the extended time period 218b and hence an indirect co-appearance is identified. Under such configuration with extended time periods of a co-appearance search period, an appearance of one subject can be identified in a time period before or after an appearance of one other subject, referring as an indirect co-appearance.

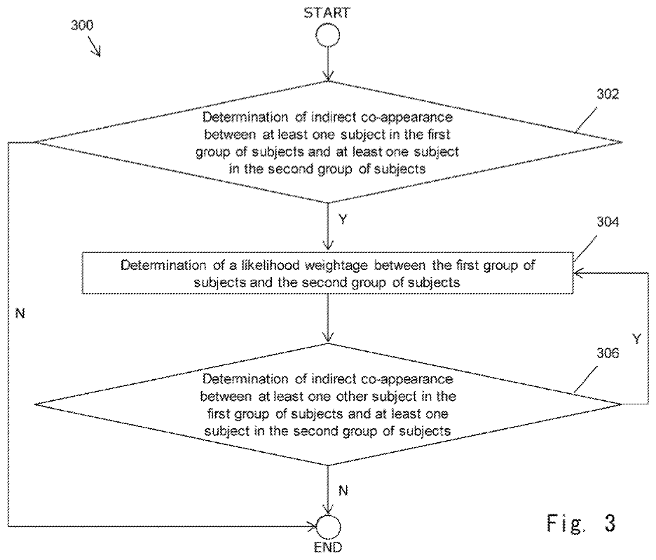

Various example embodiments provide apparatus and methods for creating a network of subjects based on a first group of subjects and a second group of subjects. FIG. 3 depicts a flow chart 300 illustrating a method of creating a network of subjects according to an example embodiment. At step 302, it is determined if at least one subject in a first group of subjects has an indirect co-appearance with at least one subject in a second group of subjects, specifically, an appearance of the at least one subjects in the first group of subjects is identified in a time period before or after an appearance of the at least one subjects in the second group of subjects based on a plurality of image frames. Subsequently, at step 304, based on the determination of the indirect co-appearance, a network of subjects comprising the first group of subjects and the second group of subjects is formed, and a likelihood weightage between the first group of subjects and the second group of subjects is determined. According to the present disclosure, the determination of the likelihood weightage may be based on a number of indirect co-appearances of the at least one subject in the first group of subjects and the at least one subject in the second group of subjects during a plurality of time periods in which indirect co-appearances between the at least one subject in the first group of subjects and the at least one subject in the second group of subjects are determined.

The method further comprises a step of determining if at least one other subject in the first group of subjects has an indirect co-appearance with the at least one subject in the second group of subjects, as depicted at 306 in FIG. 3. Based on the determination of the indirect co-appearance, the likelihood of weightage between the first group of subjects and the second group of subjects may be further determined. Similarly, the further determination of the likelihood weightage at 304 may be based on a number of indirect co-appearances of the at least one other subject in the first group of subjects and the at least one subject in the second group of subjects during a plurality of time periods in which indirect co-appearances between the at least one other subject in the first group of subjects and the at least one subject in the second group of subjects are determined.

According to an example embodiment, at step 302, the method may further comprise a step of determining if the number of indirect co-appearance of the at least one subject in the first group of subjects and the at least one subject in the second group of subjects exceeds a threshold number wherein the network of subjects or the likelihood weightage between the first group of subjects and the second group of subjects will be determined based on the number of indirect co-appearance, subsequently at step 304. Additionally or alternatively, at step 306, the method may further comprise a step of determining if the number of indirect co-appearance of the at least one other subject in the first group of subjects and the at least one subject in the second group of subjects exceeds a threshold number wherein the network of subjects or the likelihood weightage between the first group of subjects and the second group of subjects will be determined based on the number of indirect co-appearance, subsequently at step 304.

According to another example embodiment, each group of subjects like the first group of subjects and the second group of subjects may be determined through direct co-appearances. As such, the method may further comprise steps of determining if at least one subject in the first group of subjects has a direct co-appearance with at least one other subject in the first group of subjects, and if at least one subject in the second group of subjects has a direct co-appearance with at least one other subject in the second group of subjects. Additionally, the method may further comprise a step of determining if a number of direct co-appearance of the at least one subject in the first group of subjects and the at least one other subjects in the first group of subjects and a number of direct co-appearance of the at least one subject in the second group of subjects and the at least one other subject in the second group of subjects exceed a threshold number.

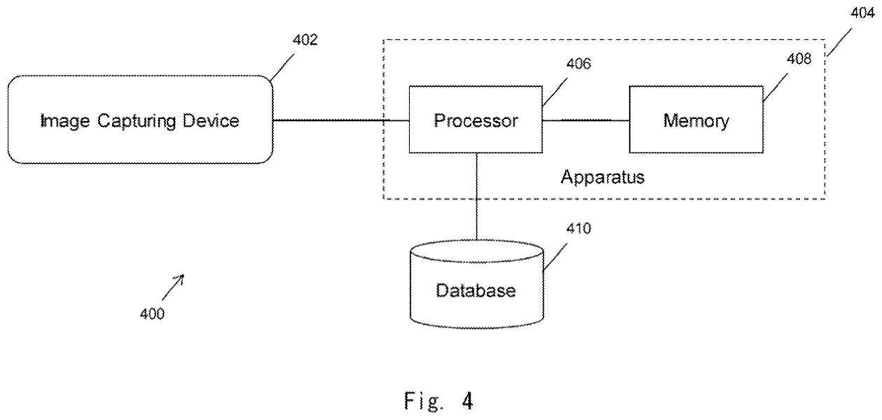

FIG. 4 shows a block diagram illustrating a system 400 for creating network of subjects based on a first group of subjects and a second group of subjects according to an example embodiment. In an example, the managing of image input is performed by at least an image capturing device 402 and an apparatus 404. The system 400 comprises an image capturing device 402 in communication with the apparatus 404. In an implementation, the apparatus 404 may be generally described as a physical device comprising at least one processor 406 and at least one memory 408 including computer program code. The at least one memory 408 and the computer program code are configured to, with the at least one processor 406, cause the physical device to perform the operations described in FIG. 3. The processor 406 is configured to receive a plurality of image frames from the image capturing device 402 or to retrieve a plurality of image frames from a database 410.

The image capturing device 402 may be a device such as a closed-circuit television (CCTV) which provides a variety of information of which characteristic information and time information that can be used by the system to determine appearances and co-appearances. In an implementation, the characteristic information derived from the image capturing device 402 may include facial information of known or unknown subject. For example, the facial information of the known subject may be that closely linked to a criminal activity which is identified by an investigator and stored in memory 408 of the apparatus 404 or a database 410 accessible by the apparatus 404. In an implementation, the time information derived from the image capturing device 402 may include time period in which a subject is identified. The time periods may be stored in memory 408 of the apparatus 404 or a database 410 accessible by the apparatus 404 to draw a relationship among known or unknown subjects in a criminal activity. It should be appreciated that the database 410 may be a part of the apparatus 404.

The apparatus 404 may be configured to communicate with the image capturing device 402 and the database 410. In an example, the apparatus 404 may receive, from the image capturing device 402, or retrieve from the database 410, a plurality of image frames as input, and after processing by the processor 406 in apparatus 404, generate an output which may be used to create a network of subjects based on a first group of subjects and a second group of subjects.

In an example embodiment, after receiving a plurality of image frames from the image capturing device 402 or retrieving a plurality of image frames from the database 410, the memory 408 and the computer program code stored therein are configured to, with the processor 406, cause the apparatus 404 to determine if at least one subject in the first group of subjects has an indirect co-appearance with at least one subject in the second group of subjects, and subsequently determine a likelihood of weightage between the first group of subjects and the second group of subjects based on the determination of the indirect co-appearance. The apparatus 404 is further configured to determine a number of indirect co-appearances of the at least one subject in the first group of subjects and the at least one subject in the second group of subjects based on the plurality of image frames received from the image capturing device 402 or retrieved from the database 410. In an example embodiment, the number of indirect co-appearances may be retrieved from the memory 408 of the 404 or the database 410 accessible by the apparatus 404. The apparatus 404 may also be configured to determine if the number of indirect co-appearance of the at least one subject in the first group of subjects and the at least one subject in the second group of subjects exceeds a threshold number stored in the memory 408 of the apparatus 404.

The apparatus 404 is further configured to determine if at least one other subject in the first group of subjects has an indirect co-appearance with the at least one subject in the second group of subject, and subsequently, the likelihood weightage between the first group of subjects and the second group of subjects is further determined based on the determination of the indirect co-appearance. The apparatus 404 is further configured to determine a number of indirect co-appearances of the at least one other subject in the first group of subjects and the at least one subject in the second group of subjects based on the plurality of image frames received from the image capturing device 402 or retrieved from the database 410. In an example embodiment, the number of indirect co-appearance may be retrieved from the memory 408 of the apparatus 404 or the database 410 accessible by the apparatus 404. The apparatus 404 may also be configured to determine if the number of indirect co-appearance of the at least one other subject in the first group of subjects and the at least one subject in the second group of subjects exceeds a threshold number stored in the memory 408 of the apparatus 404.

In an example embodiment, after receiving a plurality of image frames from the image capturing device 402 or retrieving a plurality of image frames from the database 410, the memory 408 and the computer program code stored therein are configured to, with the processor 406, cause the apparatus 404 to determine if at least one subject in the first group of subjects has a direct co-appearance with at least one other subject in the first group of subjects, and if at least one subject in the second group of subjects has a direct co-appearance with at least one other subject in the second group of subjects.

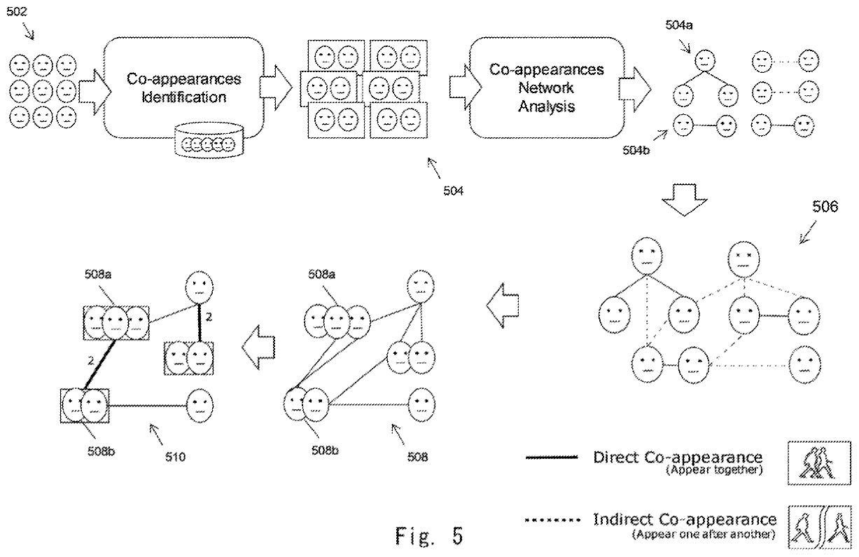

FIG. 5 depicts an example of creating a network of subjects according to an example embodiment. One or more appearances of a plurality of subjects 502 may be determined based on time information and characteristic information such as facial information from a plurality of image frames received from at least one image capturing device like 402 or retrieved from a database 410. Subsequently, indirect and direct co-appearances between every two subjects will be identified based on the one or more appearances of the plurality of subjects 502 and their corresponding time periods. As a result, a plurality of subjects with indirect/direct co-appearances 504 may be determined. Subsequently, a co-appearance network analysis may be performed to determine a group of subjects based on direct co-appearances. In particular, all subjects with direct co-appearances with one another will be combined together as a group of subjects like 504a. As a result, at least a first group of subjects and a second group of subjects may be formed based on the determination of the direct co-appearances, for example 504a, 504b. Further, it is determined if at least one subject in a first group of subjects like 504a has an indirect co-appearance with at least one subject in a second group of subjects like 504b, create a network of subjects 506 between the first group of subjects and the second group of subjects. The network of subject 506 can be further simplified by packing alongside all subjects in a group of subjects (direct co-appearance), as shown at 508. Subsequently, a likelihood of weightage between the first group of subjects like 508a and the second group of subjects like 508b are determined based on all indirect co-appearances and numbers of indirect co-appearances identified between the first group of subjects and the second group of subjects. For example in a network of subjects 508, the likelihood weightage between the two groups of subjects 508a, 508b will be determined based the determination of the two indirect co-appearances in between, and the respective numbers of indirect co-appearances of the two indirect co-appearances, as illustrated at 510.

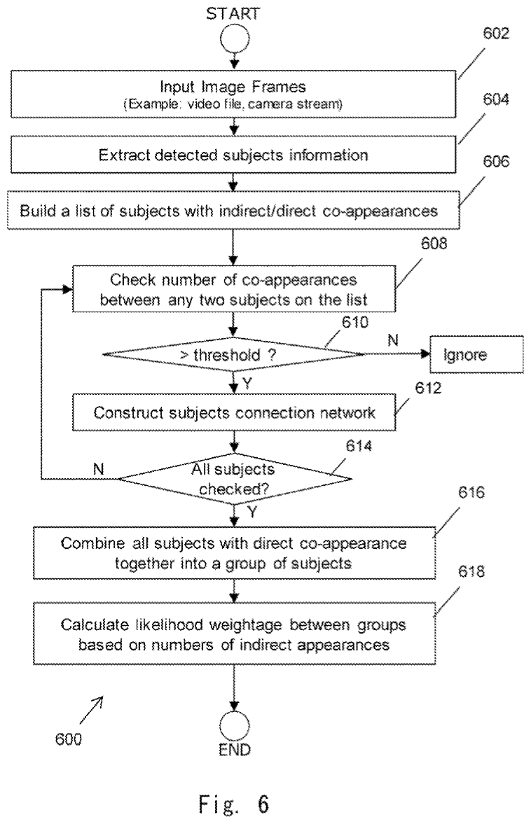

FIG. 6 depicts a flow chart 600 illustrating a method of creating a network of subjects according to an example embodiment. At step 602, a plurality of image frames may be received from at least an image capturing device like 402 or retrieved from a database 410. At step 604, one or more appearances of a plurality of subjects may be determined based on characteristic information such as facial information from the plurality of image frames. At step 606, co-appearance identification may be carried out to determine indirect and direct co-appearances between every two subjects based on the one or more appearances and corresponding time periods of the plurality of subjects. As a result, a list of subjects with indirect/direct co-appearances may be determined and stored in memory 408 of the apparatus 404 or a database 410 accessible by the apparatus 404. Subsequently, at step 608, a co-appearance network analysis may be carried out by calculating a number of indirect co-appearance or a number of direct co-appearance from the list of subjects with indirect/direct co-appearance and determined if the number of indirect co-appearance or the number of direct co-appearance exceed a threshold number, as illustrated at 610, and the two subjects with the direct co-appearance or the indirect co-appearance will then be used to construct subjects connection network at 612 or in co-appearance network analysis shown in FIG. 5, or if the number of indirect co-appearance or direct co-appearance fall below the threshold number, the two subjects with the direct co-appearance or the indirect co-appearance will be omitted in the subsequent construction of subjects connection network 612 or in the co-appearance network analysis. At step 614 as all subjects in the list of subjects with indirect/direct co-appearance have been checked against the threshold number, a group of subjects will then be determined based on direct co-appearances. In particular, all subjects with direct co-appearances with one another will be combined together as a group of subjects, and may result in a plurality of groups of subjects comprising at least a first group of subjects and a second of group subjects, at step 616. Further, the method comprises step 618 of creating a network of subjects comprising at least the first group of subjects and the second group of subject based on indirect co-appearances between the first group of subjects and the second group of subjects, and calculating a likelihood of weightage between the first group of subjects and the second group of subjects based on all indirect co-appearances and numbers of indirect co-appearances identified between the first group of subjects and the second group of subjects, as described in FIGS. 3 and 5.

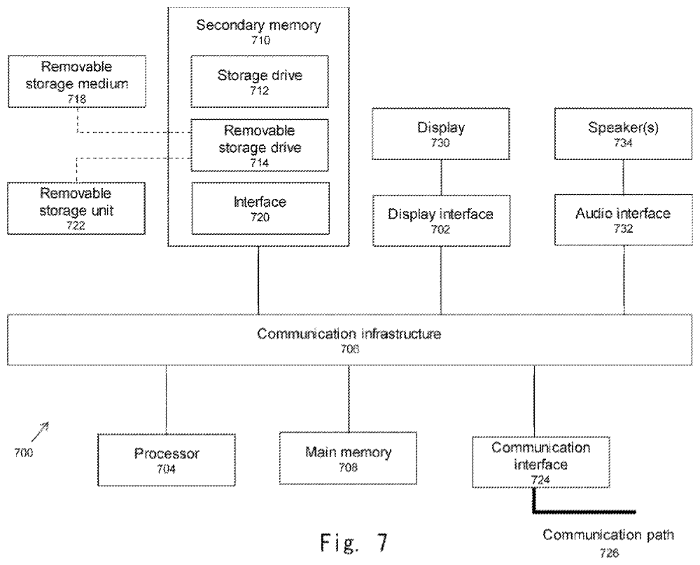

FIG. 7 depicts an exemplary computing device 700, hereinafter interchangeably referred to as a computer system 700 or as a device 700, where one or more such computing devices 700 may be used to implement the apparatus 404 shown in FIG. 4. The following description of the computing device 700 is provided by way of example only and is not intended to be limiting.

As shown in FIG. 7, the example computing device 700 includes a processor 704 for executing software routines. Although a single processor is shown for the sake of clarity, the computing device 700 may also include a multi-processor system. The processor 704 is connected to a communication infrastructure 706 for communication with other components of the computing device 700. The communication infrastructure 706 may include, for example, a communications bus, cross-bar, or network.

The computing device 700 further includes a primary memory 708, such as a random access memory (RAM), and a secondary memory 710. The secondary memory 710 may include, for example, a storage drive 712, which may be a hard disk drive, a solid state drive or a hybrid drive and/or a removable storage drive 714, which may include a magnetic tape drive, an optical disk drive, a solid state storage drive (such as a USB flash drive, a flash memory device, a solid state drive or a memory card), or the like. The removable storage drive 714 reads from and/or writes to a removable storage medium 718 in a well-known manner. The removable storage medium 718 may include magnetic tape, optical disk, non-volatile memory storage medium, or the like, which is read by and written to by removable storage drive 714. As will be appreciated by persons skilled in the relevant art(s), the removable storage medium 718 includes a computer readable storage medium having stored therein computer executable program code instructions and/or data.

In an alternative implementation, the secondary memory 710 may additionally or alternatively include other similar means for allowing computer programs or other instructions to be loaded into the computing device 700. Such means can include, for example, a removable storage unit 722 and an interface 720. Examples of a removable storage unit 722 and interface 720 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 722 and interfaces 720 which allow software and data to be transferred from the removable storage unit 722 to the computer system 700.

The computing device 700 also includes at least one communication interface 724. The communication interface 724 allows software and data to be transferred between computing device 700 and external devices via a communication path 726. In various example embodiments of the inventions, the communication interface 724 permits data to be transferred between the computing device 700 and a data communication network, such as a public data or private data communication network. The communication interface 724 may be used to exchange data between different computing devices 700 which such computing devices 700 form part an interconnected computer network. Examples of a communication interface 724 can include a modem, a network interface (such as an Ethernet card), a communication port (such as a serial, parallel, printer, GPIB, IEEE 1394, RJ45, USB), an antenna with associated circuitry and the like. The communication interface 724 may be wired or may be wireless. Software and data transferred via the communication interface 724 are in the form of signals which can be electronic, electromagnetic, optical or other signals capable of being received by communication interface 724. These signals are provided to the communication interface via the communication path 724.

As shown in FIG. 7, the computing device 700 further includes a display interface 702 which performs operations for rendering images to an associated display 730 and an audio interface 732 for performing operations for playing audio content via associated speaker(s) 734.

As used herein, the term “computer program product” (or computer readable medium, which may be a non-transitory computer readable medium) may refer, in part, to removable storage medium 718, removable storage unit 722, a hard disk installed in storage drive 712, or a carrier wave carrying software over communication path 726 (wireless link or cable) to communication interface 724. Computer readable storage media (or computer readable media) refers to any non-transitory, non-volatile tangible storage medium that provides recorded instructions and/or data to the computing device 700 for execution and/or processing. Examples of such storage media include magnetic tape, CD-ROM, DVD, Blu-Ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 700. Examples of transitory or non-tangible computer readable transmission media that may also participate in the provision of software, application programs, instructions and/or data to the computing device 700 include radio or infra-red transmission channels as well as a network connection to another computer or networked device, and the Internet or Intranets including e-mail transmissions and information recorded on Websites and the like.

The computer programs (also called computer program code) are stored in primary memory 508 and/or secondary memory 710. Computer programs can also be received via the communication interface 724. Such computer programs, when executed, enable the computing device 700 to perform one or more features of example embodiments discussed herein. In various example embodiments, the computer programs, when executed, enable the processor 704 to perform features of the above-described example embodiments. Accordingly, such computer programs represent controllers of the computer system 700.

Software may be stored in a computer program product and loaded into the computing device 700 using the removable storage drive 714, the storage drive 712, or the interface 720. The computer program product may be a non-transitory computer readable medium. Alternatively, the computer program product may be downloaded to the computer system 700 over the communications path 726. The software, when executed by the processor 704, causes the computing device 700 to perform functions of example embodiments described herein.

It is to be understood that the example embodiment of FIG. 7 is presented merely by way of example. Therefore, in some example embodiments one or more features of the computing device 700 may be omitted. Also, in some example embodiments, one or more features of the computing device 700 may be combined together. Additionally, in some example embodiments, one or more features of the computing device 700 may be split into one or more component parts. For example, the primary memory 708 and/or the secondary memory 710 may serve(s) as the memory 408 for the apparatus 404; while the processor 704 may serve as the processor 406 of the apparatus 404.

It will be appreciated by a person skilled in the art that numerous variations and/or modifications may be made to the present invention as shown in the specific example embodiments without departing from the spirit or scope of the invention as broadly described. For example, the above description mainly presenting alerts on a visual interface, but it will be appreciated that another type of alert presentation, such as sound alert, can be used in alternate embodiments to implement the method. Some modifications, e.g. adding an access point, changing the log-in routine, etc. may be considered and incorporated. The present example embodiments are, therefore, to be considered in all respects to be illustrative and not restrictive.

This application is based upon and claims the benefit of priority from Singapre Patent Application NO. 10201908202R, filed on 5 Sep. 2019, the disclosure of which is incorporated herein in its entirety by reference.

[Supplementary Note]

The whole or part of the example embodiments disclosed above can be described as, but not limited to, the following supplementary notes.

(Supplementary Note 1)

A method for creating a network of subjects based on a first group of subjects and a second group of subjects, comprising:

determining if at least one subject in the first group of subjects has an indirect co-appearance with at least one subject in the second group of subjects, the indirect co-appearance referring to an appearance of the at least one subject in the first group of subjects in a time period before or after the at least one subject in the second group of subjects; and

determining a likelihood of weightage between the first group of subjects and the second group of subjects to create the network based on the determination of the indirect co-appearance.

(Supplementary Note 2)

The method of supplementary note 1, further comprising:

determining a number of indirect co-appearance of the at least one subject in the first group of subjects and the at least one subject in the second group of subjects, wherein the likelihood of weightage is calculated based on the number of indirect co-appearance of the at least one subject in the first group of subjects and the at least one subject in the second group of subjects.

(Supplementary Note 3)

The method of supplementary note 2, wherein the step of determining a likelihood of weightage between the first group of subjects and the second group of subjects comprising:

determining if at least one other subject in the first group of subjects has an indirect co-appearance with the at least one subject in the second group of subjects.

(Supplementary Note 4)

The method of supplementary note 3, further comprising:

determining a number of indirect co-appearances of the at least one other subject in the first group of subjects and the at least one subject in the second group of subjects, wherein the likelihood of weightage is further calculated based on the number of indirect co-appearances of the at least one other subject in the first group of subjects and the at least one subject in the second group of subjects.

(Supplementary Note 5)

The method in any one of supplementary notes 1 to 4, further comprising:

determining if one or both of (i) the number of indirect co-appearances of the at least one subject in the first group of subjects and the at least one subject in the second group of subjects, and (ii) the number of indirect co-appearances of the at least one other subject in the first group of subjects and the at least one subject in the second group of subjects exceeds a threshold number, wherein the likelihood of weightage is calculated based on the one or both of the number of indirect co-appearances that exceeds the threshold number.

(Supplementary Note 6)

The method in any one of supplementary notes 1 to 5, further comprising:

determining if the at least one subject in the first group of subjects has a direct co-appearance with at least one other subject in the first group of subjects; and determining if the at least one subject in the second group of subjects has a direct co-appearance with at least one other subject in the second group of subjects; the direct co-appearance referring to an appearance of both the at least one subject in the first group of subject and the at least one other subject of the first group of subjects in a same time period.

(Supplementary Note 7)

The method of supplementary note 6, wherein the step of determining the first group of subjects comprising:

determining based on the input if a number of direct co-appearance of the at least one subject in the first group of subjects and the at least one other subject in the first group of subjects, and a number of direct co-appearance of the at least one subject in the second group of subjects and the at least one other subject in the second group of subjects exceed the threshold number.

(Supplementary Note 8)

The method in any one of supplementary notes 1 to 7, further comprising: receiving, from at least one image capturing device, a plurality of image frames, wherein the determination of the indirect co-appearance or the direct co-appearance is based on the plurality of image frames.

(Supplementary Note 9)

A apparatus for creating a network of subjects based on a first group of subjects and a second group of subjects, comprising:

a memory in communication with a processor, the memory storing a computer program recorded therein, the computer program being executable by the processor to cause the apparatus at least to:

determine if at least one subject in the first group of subjects has an indirect co-appearance with at least one subject in the second group of subjects, the indirect co-appearance referring to an appearance of the at least one subject in the first group of subjects in a time period before or after the at least one subject in the second group of subjects; and

determine a likelihood of weightage between the first group of subjects and the second group of subjects to create the network based on the determination of the indirect co-appearance.

(Supplementary Note 10)

The apparatus of supplementary note 9, wherein the memory and the computer program is executed by the processor to cause the apparatus further to:

determine a number of indirect co-appearance of the at least one subject in the first group of subjects and the at least one subject in the second group of subjects, wherein the likelihood of weightage is calculated based on the number of indirect co-appearance of the at least one subject in the first group of subjects and the at least one subject in the second group of subjects.

(Supplementary Note 11)

The apparatus of supplementary note 9, wherein the memory and the computer program is executed by the processor to cause the apparatus further to:

determine if at least one other subject in the first group of subjects has an indirect co-appearance with the at least one subject in the second group of subjects.

(Supplementary Note 12)

The apparatus of supplementary note 11, wherein the memory and the computer program is executed by the processor to cause the apparatus further to:

determine a number of indirect co-appearances of the at least one other subject in the first group of subjects and the at least one subject in the second group of subjects based on the input; wherein the likelihood of weightage is further calculated based on the number of indirect co-appearances of the at least one other subject in the first group of subjects and the at least one subject in the second group of subjects.

(Supplementary Note 13)

The apparatus in any one of supplementary notes 9 to 12, wherein the memory and the computer program is executed by the processor to cause the apparatus further to:

determine if one or both of (i) the number of indirect co-appearances of the at least one subject in the first group of subjects and the at least one subject in the second group of subjects, and (ii) the number of indirect co-appearances of the at least one other subject in the first group of subjects and the at least one subject in the second group of subjects exceeds a threshold number, wherein the likelihood of weightage is calculated based on the one or both of the number of indirect co-appearances that exceeds the threshold number.

(Supplementary Note 14)

The apparatus in any one of supplementary notes 9 to 13, wherein the memory and the computer program is executed by the processor to cause the apparatus further to:

determine if the at least one subject in the first group of subjects has a direct co-appearance with at least one other subject in the first group of subjects; and determine if the at least one subject in the second group of subjects has a direct co-appearance with at least one other subject in the second group of subjects; the direct co-appearance referring to an appearance of both the at least one subject in the first group of subject and the at least one other subject of the first group of subjects in a same time period.

(Supplementary Note 15)

The apparatus of supplementary note 14, wherein the memory and the computer program is executed by the processor to cause the apparatus further to: determine based on the input if a number of direct co-appearance of the at least one subject in the first group of subjects and the at least one other subject in the first group of subjects, and a number of direct co-appearance of the at least one subject in the second group of subjects and the at least one other subject in the second group of subjects exceed the threshold number.

(Supplementary Note 16)

The apparatus in any one of supplementary notes 9 to 15, wherein the memory and the computer program is executed by the processor to cause the apparatus further to:

receive, from at least one image capturing device, a plurality of image frames, wherein the determination of the indirect co-appearance or the direct co-appearance is based on the plurality of image frames.

(Supplementary Note 17)

A system for creating a network of subjects based on a first group of subjects and a second group of subjects, comprising:

the apparatus as claimed in any one of supplementary notes 9 to 16 and at least one image capturing device.

What is claimed is:

1. A method for creating a network of subjects based on a first group of subjects and a second group of subjects, comprising:
determining if at least one subject in the first group of subjects has an indirect co-appearance with at least one subject in the second group of subjects, the indirect co-appearance referring to an appearance of the at least one subject in the first group of subjects in a time period before or after the at least one subject in the second group of subjects; and
determining a likelihood of weightage between the first group of subjects and the second group of subjects to create the network based on the determination of the indirect co-appearance.

2. The method of claim 1, further comprising:
determining a number of indirect co-appearance of the at least one subject in the first group of subjects and the at least one subject in the second group of subjects, wherein the likelihood of weightage is calculated based on the number of indirect co-appearance of the at least one subject in the first group of subjects and the at least one subject in the second group of subjects.

3. The method of claim 2, wherein the step of determining a likelihood of weightage between the first group of subjects and the second group of subjects comprising:
determining if at least one other subject in the first group of subjects has an indirect co-appearance with the at least one subject in the second group of subjects.

4. The method of claim 3, further comprising:
determining a number of indirect co-appearances of the at least one other subject in the first group of subjects and the at least one subject in the second group of subjects, wherein the likelihood of weightage is further calculated based on the number of indirect co-appearances of the at least one other subject in the first group of subjects and the at least one subject in the second group of subjects.

5. The method in claim 1, further comprising:
determining if one or both of (i) the number of indirect co-appearances of the at least one subject in the first group of subjects and the at least one subject in the second group of subjects, and (ii) the number of indirect co-appearances of the at least one other subject in the first group of subjects and the at least one subject in the second group of subjects exceeds a threshold number, wherein the likelihood of weightage is calculated based on the one or both of the number of indirect co-appearances that exceeds the threshold number.

6. The method in claim 1, further comprising:
determining if the at least one subject in the first group of subjects has a direct co-appearance with at least one other subject in the first group of subjects; and
determining if the at least one subject in the second group of subjects has a direct co-appearance with at least one other subject in the second group of subjects; the direct co-appearance referring to an appearance of both the at least one subject in the first group of subject and the at least one other subject of the first group of subjects in a same time period.

7. The method of claim 6, wherein the step of determining the first group of subjects comprising:
determining based on the input if a number of direct co-appearance of the at least one subject in the first group of subjects and the at least one other subject in the first group of subjects, and a number of direct co-appearance of the at least one subject in the second group of subjects and the at least one other subject in the second group of subjects exceed the threshold number.

8. The method in claim 1, further comprising:
receiving, from at least one image capturing device, a plurality of image frames, wherein the determination of the indirect co-appearance or the direct co-appearance is based on the plurality of image frames.

9. A apparatus for creating a network of subjects based on a first group of subjects and a second group of subjects, comprising:
a memory in communication with a processor, the memory storing a computer program recorded therein, the computer program being executable by the processor to cause the apparatus at least to:
determine if at least one subject in the first group of subjects has an indirect co-appearance with at least one subject in the second group of subjects, the indirect co-appearance referring to an appearance of the at least one subject in the first group of subjects in a time period before or after the at least one subject in the second group of subjects; and
determine a likelihood of weightage between the first group of subjects and the second group of subjects to create the network based on the determination of the indirect co-appearance.

10. The apparatus of claim 9, wherein the memory and the computer program is executed by the processor to cause the apparatus further to:
determine a number of indirect co-appearance of the at least one subject in the first group of subjects and the at least one subject in the second group of subjects, wherein the likelihood of weightage is calculated based on the number of indirect co-appearance of the at least one subject in the first group of subjects and the at least one subject in the second group of subjects.

11. The apparatus of claim 9, wherein the memory and the computer program is executed by the processor to cause the apparatus further to:
determine if at least one other subject in the first group of subjects has an indirect co-appearance with the at least one subject in the second group of subjects.

12. The apparatus of claim 11, wherein the memory and the computer program is executed by the processor to cause the apparatus further to:
determine a number of indirect co-appearances of the at least one other subject in the first group of subjects and the at least one subject in the second group of subjects based on the input; wherein the likelihood of weightage is further calculated based on the number of indirect co-appearances of the at least one other subject in the first group of subjects and the at least one subject in the second group of subjects.

13. The apparatus in claim 9, wherein the memory and the computer program is executed by the processor to cause the apparatus further to:
determine if one or both of (i) the number of indirect co-appearances of the at least one subject in the first group of subjects and the at least one subject in the second group of subjects, and (ii) the number of indirect co-appearances of the at least one other subject in the first group of subjects and the at least one subject in the second group of subjects exceeds a threshold number, wherein the likelihood of weightage is calculated based on the one or both of the number of indirect co-appearances that exceeds the threshold number.

14. The apparatus in claim 9, wherein the memory and the computer program is executed by the processor to cause the apparatus further to:
determine if the at least one subject in the first group of subjects has a direct co-appearance with at least one other subject in the first group of subjects; and determine if the at least one subject in the second group of subjects has a direct co-appearance with at least one other subject in the second group of subjects; the direct co-appearance referring to an appearance of both the at least one subject in the first group of subject and the at least one other subject of the first group of subjects in a same time period.

15. The apparatus of claim 14, wherein the memory and the computer program is executed by the processor to cause the apparatus further to:
determine based on the input if a number of direct co-appearance of the at least one subject in the first group of subjects and the at least one other subject in the first group of subjects, and a number of direct co-appearance of the at least one subject in the second group of subjects and the at least one other subject in the second group of subjects exceed the threshold number.

16. The apparatus in claim 9, wherein the memory and the computer program is executed by the processor to cause the apparatus further to:
receive, from at least one image capturing device, a plurality of image frames, wherein the determination of the indirect co-appearance or the direct co-appearance is based on the plurality of image frames.

17. A system for creating a network of subjects based on a first group of subjects and a second group of subjects, comprising:
the apparatus as claimed in claim 9 and at least one image capturing device.
